(19) United States
(12) Patent Application Publication
(10) Pub. No.: US 2005/0262762 A1
(43) Pub. Date: Dec. 1, 2005

(54) Method of sticking plant seeds on a seed fixing film mat and construction thereof

(76) Inventor: Wen-Tsan Ko, Jhubei City (TW)

Correspondence Address: TROXELL LAW OFFICE PLLC, SUITE 1404, 5205 LEESBURG PIKE, FALLS CHURCH, VA, 22041, US

(21) Appl. No.: 10/853,257

(22) Filed: May 26, 2004

(51) Int. Cl. A01C 1/04

(52) U.S. Cl. 47/56

(57) ABSTRACT

Method of sticking plant seeds on a seed fixing film mat and construction thereof in which a plant seed is formed into a multi-layered structure by enclosing the plant seed with a first and a second gel enclosures intercalated a layer of additive between the two gel enclosures. Afterwards, the one or several enclosed plant seed constructed as such is placed on a seed fixing film mat with an equal spacing and stuck to the seed fixing film mat by heating and fusing the gel enclosures. The plant is nourished directly by the additive so as to eliminate regular fertilizing work thereby the cultivation procedures can be simplified and production cost curtailed.

### BACKGROUND OF THE INVENTION

1. Field of the Invention

The present invention relates to a method of sticking plant seeds on a seed fixing film mat and construction thereof, in particular, a method in which a plant seed enclosed by single or multiple gel enclosure is stuck on a seed fixing film mat so as to simplify the cultivation procedures, improve harvest and curtail production cost.

2. Description of the Prior Art

The traditional way of plants or vegetables raising has to go through a series of tedious procedures such as scarification, seeding, fertilizing, disinfecting, sprinkling, and weeding before attaining the goal of a rich harvest. It is understood that the above procedures can be carried out either manually by spending intensive man power, or mechanically by investing a great deal of money for purchasing tools and equipment. Both of the above ways cause a great burden to the producer.

For these shortcomings inherent to the traditional agricultural techniques, being a man skilled in the art and always attentive to the refined agriculture, the inventor has put forth every effort for years by continuous research and experimentation in an attempt to palliate the aforesaid shortcomings, and finally come up with the present invention.

### SUMMARY OF THE INVENTION

These features and advantages of the present invention will be fully understood and appreciated from the following detailed description of the accompanying Drawings.

An object of the present invention is to provide a method of sticking plant seeds on a seed fixing film mat and construction thereof in which a plant seed enclosed with single or multiple enclosures is stuck on a seed fixing film sheet by heating so as to simplify the cultivation procedures, improve harvest, and curtail production cost.

Another object of the present invention is to provide a multi-layered seed structure for variety of products to attain similar effect to meet different interests and requirements of consumers and producers.

Another object is that the method and construction of the plant seed according to the present invention to be capable of contributing to promotion and modernization of the agricultural technology.

To achieve these and other objects mentioned above, the plant seed of the present invention is enclosed with multi-layered gel enclosures with a layer of an additive intercalated between adjacent gel enclosures. Then the seed constructed as such is stuck on a seed fixing film mat by fusing the gel enclosures with heat. The additives intercalated between the adjacent gel enclosures can release their nourishing ingredients gradually during the growing period of the plant so as to save the tedious fertilizing work.

The plant seed constructed as such is not only effective for simplifying plant raising procedure but also prolonging storable time for the plant seeds. Its progressiveness and practicalness make the present invention applicable for raising all kinds of plants including vegetables.

### BRIEF DESCRIPTION OF THE DRAWINGS

FIG. 1A through FIG. 1D are the views for illustrating steps of sticking plant seeds on a seed fixing film mat and the construction thereof according to the present invention;

FIG. 2 is a perspective view of the present invention; and

FIGS. 3A and 3B are illustrative views showing how the plant seed is stuck on the seed fixing film mat by fusing the gel enclosures with a high temperature.

### DETAILED DESCRIPTION OF THE PREFERRED EMBODIMENT

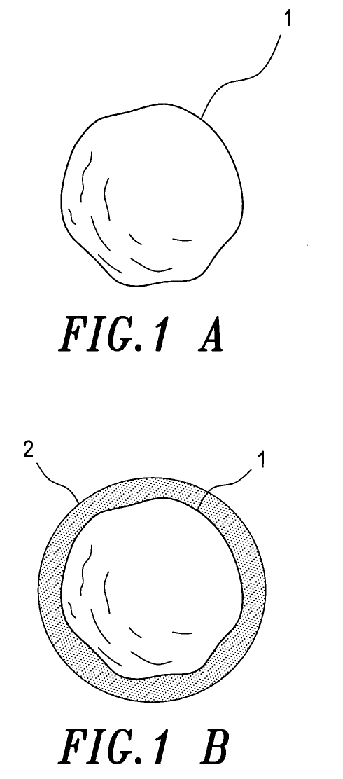

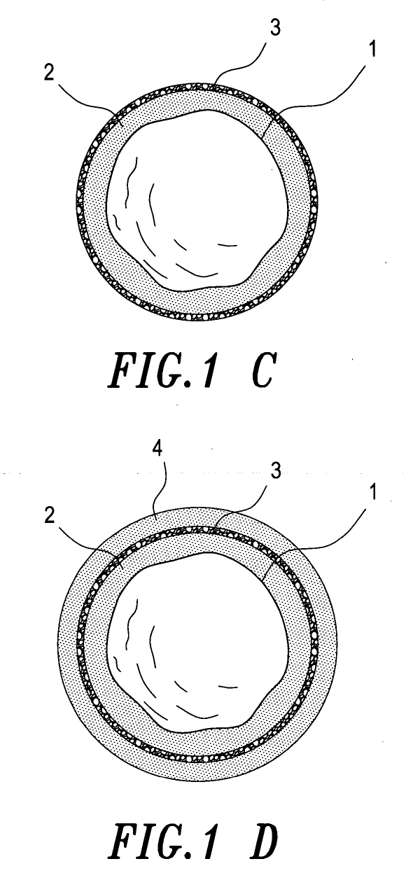

Now, the steps of sticking plant seeds on a seed fixing film mat will be described with reference to the accompanied drawings FIG. 1 through FIG. 3. The construction of the present invention is composed of:

a plant seed 1 selected from edible plants or vegetables;

a first gel enclosure 2 enclosing over the plant seed 1;

a layer of additive 3 enclosing over the first gel enclosure 2, the additive 3 includes a variety of substances such as seed preservative, nutrient, fertilizer, insecticide, or bactericide according to the requirements and functions of the plants;

a second gel enclosure 4 enclosing over the additive layer 3; and

a seed fixing film mat 5 for fixing the multi-layer plant seed 1, the seed fixing film mat 5 is a dissolvable type or a herbicidal, undissolvable type depending on its composing ingredients.

Meanwhile, the method of sticking plant seeds on the seed fixing film mat comprises the steps of:

Step 1: Enclosing a plant seed 1 (edible plant or vegetable) with a first gel enclosure 2 (see FIGS. 1A and 1B).

Step 2: Enclosing a layer of additive 3 (see FIG. 1C) over the first gel enclosure 2 which being enclosing the plant seed 1.

Step 3: Enclosing a second gel enclosure 4 over the layer or additive 3 (see FIG. 1D); and

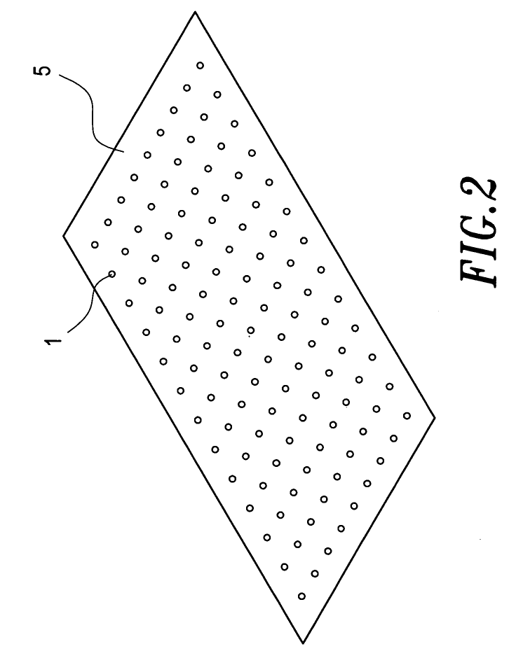

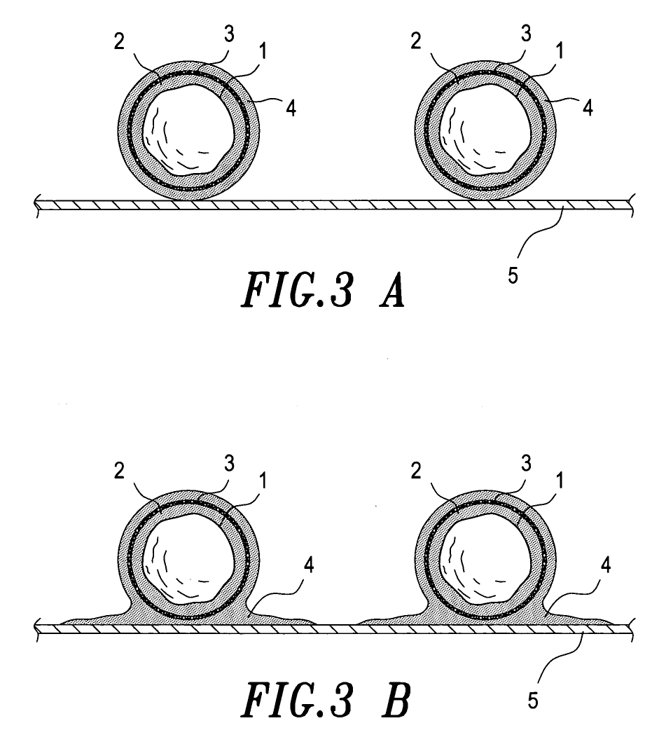

Step 4: Placing one or several plant seeds 1 on a seed fixing film mat 5 (see FIG. 2) with equal spacing and then fusing the outmost second gel enclosure 4 by heating so as to stick the plant seed (or seeds) 1 on the seed fixing film mat 5 (see FIGS. 3A and 3B).

After that, the seed fixing film 5 is directly laid on the plant field, the first and second gel enclosures 2, 4 will be dissolved by watering such that the layer 3 can gradually release its additive to nourish the plant seeds 1 by mixing the additive with the gel material thereby the tedious fertilizing work can be eliminated and cultivation procedures simplified.

It emerges from the above description that the present invention has several noteworthy advantages compared with the conventional method of raising plants or vegetables, in particular:

1. The method of the present invention is applicable for growing any kinds of plant seeds with significant effects of increasing harvest and curtailing production cost thereby contributing to the promotion of agricultural technology.

2. The intercalation of additives containing various substance such as seed preservative, nutrient, fertilizer, insecticide, bactericide etc. serves to accelerate plant growth and simplify tedious routine field work.

3. The seed fixing film mat can be conveniently laid on the field without particular environmental consideration.

4. The seed fixing film mat is divided into a dissolvable and an undissolvable types depending on their consisting ingredients so as to fit for the land containing different kinds of soils.

Many changes and modifications in the above described embodiment of the invention can, of course, be carried out without departing form the scope thereof. Accordingly, to promote the progress in science and the useful arts, the invention is disclosed and is intended to be limited by the scope of the appended claims.

1-10. (canceled)

11. A method of sticking plant seeds on a seed fixing film mat, which comprises the steps of:
a) preparing a seed;
b) coating an outer periphery of the seed with a first gel enclosure;
c) coating an outer periphery of the first gel enclosure with an additive layer;
d) coating an outer periphery of the additive layer with a second gel layer; and
e) utilizing a heating process to connect the second get layer to the seed fixing film mat.

12. The method according to claim 11, wherein in the coating step c) the additive layer includes at least one substance selected from a group consisting of a seed preservative, a nutrient, a fertilizer, an insecticide, a bactericide, and a combination thereof.

13. The method according to claim 11, wherein in the preparing step a), the seed is selected from a group consisting of a plant seed and a vegetable seed.
